(19) United States
(12) Patent Application Publication
(10) Pub. No.: US 2006/0123645 A1
(43) Pub. Date: Jun. 15, 2006

(54) Combination Level

(76) Inventor: Carmelo Gorgone, Brooklyn, NY (US)

Correspondence Address: LAW OFFICES OF ALOZIE N. ETUFUGH, PLLC, SUITE 4D, 30 CENTRAL PARK SOUTH, NEW YORK, NY, 10019, US

(21) Appl. No.: 10/905,014

(22) Filed: Dec. 9, 2004

(51) Int. Cl. B43L 7/00

(52) U.S. Cl. 33/451

(57) ABSTRACT

A combination level comprising an L-shaped arm and a straight arm, said arms being connected along a common longitudinal edge; said L-shaped arm having a longitudinal portion and a base portion; and, a plurality of level indicating means. The present invention relates to a combination level that allows craftsmen to level and/or plumb and square two different surfaces on two different planes simultaneously.

### BACKGROUND OF THE INVENTION

1. Field of the Invention

The present invention relates generally to a combination level used by craftsmen, such as artists, builders, cabinet makers, carpenters, contractors, draftsmen, engineers, machinists, masons, roofers, woodworkers and others for making various types of measurements, to determine whether a given structural member is level, plumb, and, square. The present invention may also be used as a measuring tool. More particularly, the present invention relates to a combination level that allows craftsmen to level and/or plumb and square two different surfaces on two different planes simultaneously.

2. Description of the Related Art

Most craftsmen's levels have at least one reference edge and one or more bubble vials for correctly aligning the reference edge along a true horizontal or vertical plane. The prior art includes U.S. Pat. No. 4,168,578, issued to VanderWerf, relates to a four way corner level; U.S. Pat. No. 6,029,359, issued to Szumer, relates to a post, pipe and sign level; and, U.S. Pat. No. 6,807,743, issued to Odachowski, relates to a square level; all three of which are hereby incorporated by reference.

However, the prior art does not teach a level that allows a craftsman to level and/or plumb and square two different surfaces on two different planes simultaneously. Usually this is a two-step process and/or a process involving more than one tool. The present invention cures these deficiencies, thereby saving time, labor and cost and increasing efficiency.

### BRIEF SUMMARY OF THE INVENTION

An object of the present invention is a combination level comprising an L-shaped arm and a straight arm, said arms being connected along a common longitudinal edge, said L-shaped arm having a longitudinal portion and a base portion; and, a plurality of level indicating means.

At least one of said plurality of level indicating means is located on said longitudinal portion. At least one of said plurality of level indicating means is located on said base portion. At least one of said plurality of level indicating means is located on said straight arm.

The combination level may further comprise a temperature indicating means. The combination level may further comprise a plurality of apertures, wherein at least one of said plurality of apertures is located on the L-shaped arm and at least one of said plurality of apertures is located on the straight arm.

Further advantages and features of the invention will become apparent from the following description and the claims.

### BRIEF DESCRIPTION OF THE SEVERAL VIEWS OF THE DRAWING

FIG. 1 is a perspective view of one of the embodiments according to the present invention.

FIG. 2 illustrates an embodiment of the present invention being used in building a corner of a brick structure.

FIG. 3 illustrates an embodiment of the present invention being used in building a brick wall structure.

### DETAILED DESCRIPTION OF THE INVENTION

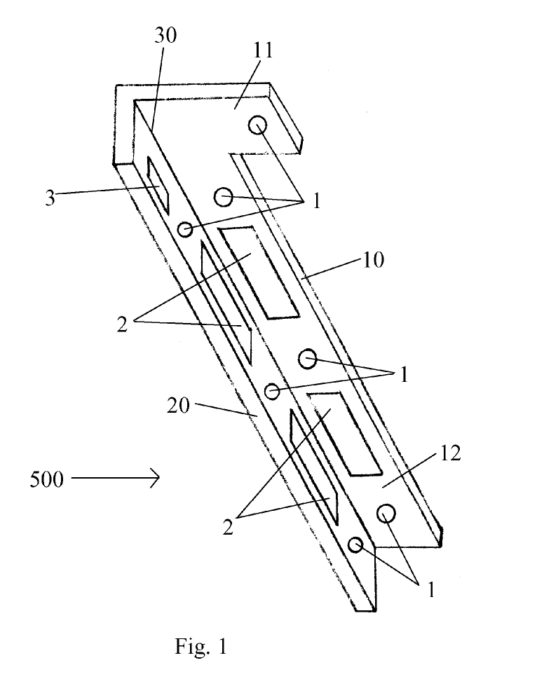

The combination level 500, as shown in FIG. 1, includes an L-shaped arm 10 and a straight arm 20 projecting perpendicular to one another from a junction 30. The overall length of the combination level 500 can be as desired.

The combination level 500 includes a plurality of level indicating means 1 and a plurality of apertures 2.

The L-shaped arm 10 has a base portion 11 and a longitudinal portion 12.

The straight arm includes a temperature indicating means 3.

The level indicating means 1 may be arranged for indicating level (true horizontal) and plumb (true vertical), respectively, of any work surface against which any one of the straight arm 20, base portion 11 of the L-shaped arm 10, or longitudinal portion 12 of the L-shaped arm 10 is pressed. The level indicating means 1 are preferably carpenter's bubbles but other devices may be used alternatively.

The plurality of apertures 2 may aid the craftsman in storing, using or transporting the combination level 500. Each of the plurality of apertures 2 may be a hole, slit or opening.

The temperature indicating means 3 are preferably fluid thermometers, but other thermometers, such as a digital thermometer, may be used alternatively. The temperature indicating means 3 may present temperature in degrees Fahrenheit or Celsius. The temperature indicating means 3 allow the mason to determine the ambient air temperature, as bricklaying should only be done when the ambient air temperature is at least about 35 degrees Fahrenheit or 3 degrees Celsius.

The combination level 500 may be constructed of metal, plastic, wood, other suitable materials, or combinations thereof.

The combination level 500 may contain a plurality of English system (e.g., inches, feet, etc) and/or International System of Units (e.g., millimeters, centimeters, etc.) indicia marks.

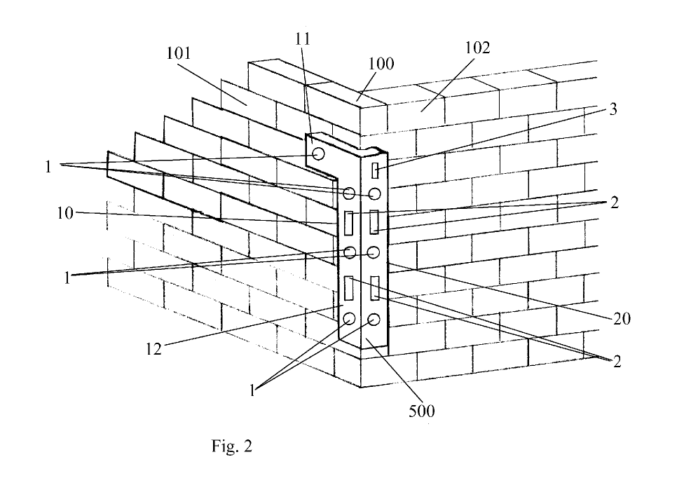

The combination level 500, as shown in FIG. 2, is used in building the corner of a brick structure 100. The L-shaped arm 10 is used to determine whether the first side 101 of the brick structure 100 is plumb; the straight arm 20 is used to determine whether the second side 102 of the brick structure 100 is plumb; and combination level 500 is used to determine the whether the first side 101 is square in relation to the second side 102 of the brick structure 100. The combination level 500 allows a single craftsman to determine these three measurements simultaneously.

A single mason may use the present invention to level and/or plumb and square two different surfaces on two different planes simultaneously. For example, when building a chimney with bricks, stones or blocks, the mason must keep the construction straight, level and square. The present invention is especially beneficial to the mason when building the corners of the chimney, where there are two surfaces that need to be level and/or plumb, the two surfaces that need to be square in relation to each other, and each surface must be straight.

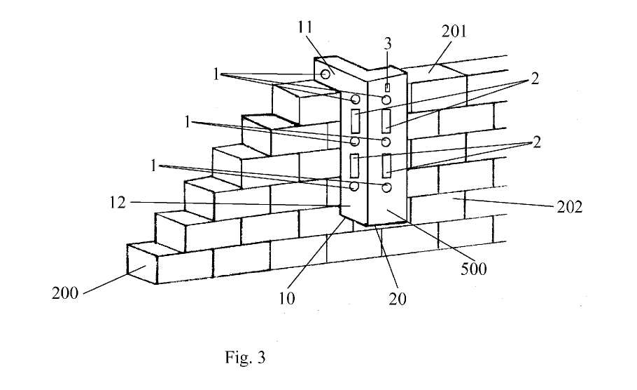

The combination level 500, as shown in FIG. 3, is used in building the brick wall structure 200. The base portion 11 of the L-shaped arm 10 is used to determine whether the top surface 201 of the brick wall structure 200 is level; the longitudinal portion 12 of the L-shaped arm 10 is used to determine whether the side surface 202 of the brick wall structure 200 is plumb; and L-shaped arm 10 is used to determine the whether the top surface 201 is square in relation to the side surface 202 of the brick wall structure 200. The combination level 500 allows a single craftsman to determine these three measurements simultaneously.

The length of the base portion 11 of the L-shaped arm 10 can be as desired. Preferably, the length would be equal to or slightly less than the widths of standard-sized bricks, as illustrated in FIG. 3. This allows a mason to construct the brick wall structure 200 without interfering with a craftsman or other construction personnel working on the other side of the brick wall structure 200. Slightly less than means the length of the base portion 11 is about one-quarter of an inch less than the width of a standard-sized brick.

The widths of standard-sized bricks include four, eight, ten and twelve inches. Thus, the length of the base portion 11 may be four inches, which would be suitable for masonry work with bricks with widths of four, eight, ten and twelve inches. A combination level 500 where the length of the base portion 11 is eight inches would be suitable for masonry work with bricks with widths of eight, ten and twelve inches. A combination level 500 where the length of the base portion 11 is ten inches would be suitable for masonry work with bricks with widths of ten and twelve inches. A combination level 500 where the length of the base portion 11 is twelve inches would be suitable for masonry work with bricks with the width of twelve inches. However, it is preferable for a mason to use a combination level 500 that is appropriately sized. For example, a combination level 500 where the length of the base portion 11 is four inches is best suited for masonry work with bricks with the width of four inches instead of twelve inches. Thus, other embodiments of the present invention may be designed where the length of the base portion 11 of the L-shaped arm 10 is four, eight, ten or twelve inches, or the width of any other standard-sized bricks. Alternatively, other embodiments of the present invention may be designed where the length of the base portion 11 of the L-shaped arm 10 is slightly less than four, eight, ten or twelve inches, or the width of any other standard-sized bricks.

The embodiments shown in FIGS. 1-3 include an L-shaped arm 10 and a straight arm 20 projecting perpendicular to one another from a junction 30. However, other embodiments of the present invention may be designed where the L-shaped arm 10 and the straight arm 20 are connected to form any angle from about five degrees to about one-hundred seventy-five degrees, as masons may build structures with corners of varying degrees.

1. A combination level comprising:
an L-shaped arm and a straight arm, said L-shaped arm and said straight arm are connected along a common longitudinal edge;
said L-shaped arm having a longitudinal portion and a base portion;
a plurality of level indicating means;
wherein the base portion is configured to determine if a top surface of a structure is level;
wherein the longitudinal portion is configured to determine if a side surface of the structure is plumb; and
wherein the L-shaped arm is configured to determine if the top surface of the structure is square in relation to the side surface of the structure.

2. The combination level according to claim 1, wherein at least one of said plurality of level indicating means is located on said longitudinal portion.

3. The combination level according to claim 1, wherein at least one of said plurality of level indicating means is located on said base portion.

4. The combination level according to claim 1, wherein at least one of said plurality of level indicating means is located on said straight arm.

5. The combination level according to claim 1 further comprising:
a temperature indicating means.

6. The combination level according to claim 5, further comprising:
a plurality of apertures.

7. The combination level according to claim 6, wherein at least one of said plurality of apertures is located on said L-shaped arm.

8. The combination level according to claim 6, wherein at least one of said plurality of apertures is located on said straight arm.

9. The combination level according to claim 1, wherein the structure is a brick wall structure.
